(19) United States
(12) Patent Application Publication
(10) Pub. No.: US 2024/0117159 A1
(43) Pub. Date: Apr. 11, 2024

(54) Tire Having Tread Of Specified Rubber Composition And Related Methods

(71) Applicant: Bridgestone Americas Tire Operations, LLC, Nashville, TN (US)

(72) Inventors: Dennis C. Boley, Mogadore, OH (US); Jamie L. Whyte, Kent, OH (US)

(21) Appl. No.: 18/259,209

(22) PCT Filed: Dec. 30, 2021
(86) PCT No.: PCT/US21/73185

§ 371 Date: Jun. 23, 2023

Related U.S. Application Data
(60) Provisional application No. 63/132,051, filed on Dec. 30, 2020.

(51) Int. Cl. C08L 7/00; B60C 1/00; B60C 11/00

(52) U.S. Cl. CPC C08L 7/00; B60C 1/0016; B60C 11/0008; B60C 2011/0025; C08L 2205/035

(57) ABSTRACT

Disclosed herein are tires made from a rubber composition of specified ingredients including an elastomer component, a resin component including a DCPD-based resin, a hydrocarbon resin other than a DCPD-based resin, a filler component including reinforcing silica filler and carbon black, optionally a silica coupling agent, optionally a liquid plasticizer, and a cure package.

### FIELD

The present application is directed to tires having a tread of a specified rubber compositions and related methods.

### BACKGROUND

Tires comprise many components including a road-contacting tread. The particular ingredients used to prepare the rubber composition which comprises the tire tread may vary. Formulation of tire tread rubber compositions is a complex science since changes to the formulation which result in an improvement in one property (e.g., wet performance) may result in changes to other properties.

### SUMMARY

Disclosed herein are tires having a tread of a specified rubber composition and related methods.

In one embodiment, a tire comprising a tread having improved wet performance and made from a rubber composition is disclosed. According to this embodiment, the rubber composition comprises: (a) 100 parts of an elastomer component including at least 50 parts of rubber selected from the group consisting of natural rubber and polyisoprene, (b) 5 to 40 phr of a resin component comprising a DCPD-based resin, (c) 0 to 30 phr of a hydrocarbon resin other than a DCPD-based resin, (d) a filler component comprising (i) 20 to 70 phr of a reinforcing silica filler, and (ii) 10 to 50 phr of a carbon black filler, (e) 0 to 10 phr of a silica coupling agent, (f) 0 to 30 phr of a liquid plasticizer, and (e) a cure package.

### DETAILED DESCRIPTION

Disclosed herein are tires having a tread of a specified rubber composition and related methods.

In a first embodiment, a tire comprising a tread having improved wet performance and made from a rubber composition is disclosed. According to the first embodiment, the rubber composition comprises: (a) 100 parts of an elastomer component including at least 50 parts of rubber selected from the group consisting of natural rubber and polyisoprene, (b) 5 to 40 phr of a resin component comprising a DCPD-based resin, (c) 0 to 30 phr of a hydrocarbon resin other than a DCPD-based resin, (d) a filler component comprising (i) 20 to 70 phr of a reinforcing silica filler, and (ii) 10 to 50 phr of a carbon black filler, (e) 0 to 10 phr of a silica coupling agent, (f) 0 to 30 phr of a liquid plasticizer, and (e) a cure package.

### Definitions

The terminology as set forth herein is for description of the embodiments only and should not be construed as limiting the invention as a whole.

As used herein, the term “BR” or “polybutadiene” refers to homopolymer of 1,3-butadiene.

As used herein, the term “majority” refers to more than 50% (e.g., at least 50.1%, at least 50.5%, at least 51%, etc.).

As used herein, the term “minority” refers to less than 50% (e.g., no more than 49.5%, no more than 49%, etc.).

As used herein, the abbreviation Mn is used for number average molecular weight.

As used herein, the abbreviation Mp is used for peak molecular weight.

As used herein, the abbreviation Mw is used for weight average molecular weight.

Unless otherwise indicated herein, the term “Mooney viscosity” refers to the Mooney viscosity, ML₁₊₄. As those of skill in the art will understand, a rubber composition's Mooney viscosity is measured prior to vulcanization or curing.

As used herein, the term “natural rubber” means naturally occurring rubber such as can be harvested from sources such as Hevea rubber trees and non-Hevea sources (e.g., guayule shrubs and dandelions such as TKS). In other words, the term “natural rubber” should be construed so as to exclude synthetic polyisoprene.

As used herein, the term “phr” means parts per one hundred parts rubber. The one hundred parts rubber is also referred to herein as 100 parts of an elastomer component.

As used herein the term “polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

As used herein the term “SBR” means styrene-butadiene copolymer rubber.

As used herein, the term “tread,” refers to both the portion of a tire that comes into contact with the road under normal inflation and load as well as any subtread.

### Rubber Composition of the Tire Tread

As mentioned above, the embodiments disclosed herein are directed to a tire comprising a tread having improved wet traction and made from a specified rubber composition and to a method for improving the wet traction of a tire tread by producing a specified rubber composition. The rubber compositions are used in preparing treads for tires, generally by a process which includes forming of a tread pattern by molding and curing one of the rubber compositions. Thus, the tire treads will contain a cured form of one of the rubber compositions. The rubber compositions may be present in the form of a tread which has been formed but not yet incorporated into a tire and/or they may be present in a tread which forms part of a tire.

### Elastomer Component

As mentioned above, according to certain embodiments, the rubber composition for the tire tread includes 100 parts of an elastomer component which includes at least 50 parts of rubber selected from the group consisting of natural rubber, polyisoprene, and combinations thereof. The total amount of 100 parts of elastomer or rubber is used so that the amount of other ingredients may be listed in amounts of phr or the number of parts per hundred parts of rubber (or 100 parts of the elastomer component). As a non-limiting example, for a rubber composition containing 75 parts of natural rubber, 25 parts of polybutadiene and 70 parts of reinforcing silica filler, the amount of silica filler can also be described as 70 phr. In certain such embodiments, only one of each of the foregoing rubbers is used for the elastomer component, i.e., one SBR, one BR, and one of natural rubber of polyisoprene. In certain embodiments, the elastomer component includes at least 50 parts of natural rubber and 1-50 parts of polybutadiene having a cis-bond content of at least 90% and a Tg of less than −100° C. In other embodiments, the elastomer component includes at least 20 parts of polybutadiene rubber having a cis-bond content of at least 90% and a Tg of less than −100° C.

In certain embodiments, the 100 parts of elastomer component consists (only) of rubbers selected from polybutadiene, natural rubber, polyisoprene, and combinations thereof. In other embodiments, the 100 parts of elastomer component includes one or more additional rubbers. According to certain embodiments, when one or more additional rubbers is present, the amount will generally be limited, preferably to no more than 25 parts (e.g., 25 parts, 20 parts, 15 parts, 10 parts, 5 parts, or less), no more than 15 parts (e.g., 15 parts, 10 parts, 5 parts, or less), or no more than 5 parts (e.g., 5 parts, 4 parts, 3 parts, 2 parts, 1 part, or less). In certain embodiments, one or more additional rubbers are selected from diene monomer-containing rubbers. In certain embodiments, the one or more additional rubbers (iv) are selected from the group consisting of styrene-butadiene rubber, styrene-isoprene rubber, butadiene-isoprene rubber, styrene-isoprene-butadiene rubber, butyl rubber (both halogenated and non-halogenated), ethylene-propylene rubber (EPR), ethylene-butylene rubber (EBR), ethylene-propylene-diene rubber (EPDM), and combinations thereof.

### Natural Rubber or Polyisoprene

According to certain embodiments, the elastomer component comprises natural rubber, polyisoprene, or a combination thereof. In certain embodiments, the elastomer component includes natural rubber, but not polyisoprene. In other embodiments, the elastomer component includes only polyisoprene, but not natural rubber. According to certain embodiments, when natural rubber is present in the elastomer component, it may include Hevea natural rubber, non-Hevea natural rubber (e.g., guayule natural rubber), or a combination thereof. When natural rubber is used in the rubber composition, the natural rubber preferably has a Mw of 1,000,000 to 2,000,000 grams/mole (e.g., 1 million, 1.1 million, 1.2 million, 1.3 million, 1.4 million, 1.5 million, 1.6 million, 1.7 million, 1.8 million, 1.9 million, 2 million grams/mole); 1,250,000 to 2,000,000 grams/mole, or 1,500,000 to 2,000,000 grams/mole (as measured by GPC using a polystyrene standard). When natural rubber is used in the rubber compositions, the Tg of the natural rubber may vary. Preferably, according to certain embodiments, when natural rubber is utilized it has a Tg of −65 to −80° C. (e.g., −65, −66, −67, −68, −69, −70, −71−, −72, −73, −74, −75, −76, −77, −78, −79, or −80° C.), more preferably a Tg of −67 to −77° C. (e.g., −67, −68, −69, −70, −71, −72, −73, −74, −75, −76, or −77° C.). When polyisoprene is utilized in the rubber compositions of certain embodiments, the Tg of the polyisoprene may vary. Preferably, according to certain embodiments, when polyisoprene is utilized it has a Tg of −55 to −75° C. (e.g., −55, −56, −57, −58, −59, −60, −61, −62, −63, −64, −65, −66, −67, −68, −69, −70, −71, −72, −73, −74, or −75° C.), more preferably −58 to −74° C. (e.g., −58, −59, −60, −61, −62, −63, −64, −65, −66, −67, −68, −69, −70, −71, −72, −73, or −74° C.).

According to certain, when natural rubber and/or polyisoprene are used in the rubber composition, the amount utilized may vary. Generally, according certain embodiments, the total amount of any natural rubber and/or polyisoprene present in the elastomer component will be at least 50 parts. In certain embodiments, the total amount of natural rubber and/or polyisoprene present in the elastomer component is at least 55 parts, at least 60 parts alternatively, less than 100 parts, less than 90 parts, less than 80 parts, less than 70 parts or less than 60 parts. In certain embodiments, the total amount of natural rubber and/or polyisoprene present in the elastomer component is 50-100 parts, 50-90 parts, 50-80 parts, 50-70 parts, 60-100 parts, 60-90 parts, 60-80 parts, 70-100 parts, 70-90 parts or 80-100 parts. In certain embodiments, the elastomer component includes natural rubber but no polyisoprene, and the amount of natural rubber is within one of the foregoing ranges.

### Polybutadiene

According to certain embodiments, the elastomer component of the rubber composition for the tire tread may include polybutadiene rubber. The particular type of polybutadiene rubber utilized may vary. Preferably, any polybutadiene rubber present in the elastomer component has a cis bond content of at least 90% (e.g., 90%, 91%, 92%, 93%, 94%, 95%, 96%, 97%, 98%, 99%, or more) and a Tg of less than −100° C. (e.g., −101, −102, −103, −104, −105, −106, −107, −108, −109° C. or less). In certain such embodiments, the Tg of the polybutadiene rubber is −100 to −110° C. The cis bond content refers to the cis 1,4-bond content. The cis 1,4-bond contents referred to herein are determined by FTIR (Fourier Transform Infrared Spectroscopy) wherein a polymer sample is dissolved in CS₂ and then subjected to FTIR. In certain embodiments, the polybutadiene rubber present in the elastomer component may have a cis 1,4-bond content of at least 95% (e.g., 95%, 96%, 97%, 98%, 99%, or more) or at least 98% (e.g., 98%, 99%, or more). In certain embodiments, any polybutadiene rubber present in the elastomer component has a Tg of −105° C. or less (e.g., −105, −106, −107, −108, −109° C. or less) such as −105 to −110° C. or −105 to −108° C. In certain embodiments, any polybutadiene rubber present in the elastomer component contains less than 3% by weight (e.g., 3%, 2%, 1%, 0.5%, or less), preferably less than 1% by weight (e.g., 1%, 0.5%, or less) or 0% by weight syndiotactic 1,2-polybutadiene. Generally, one or more than one polybutadiene rubber having a cis bond content of at least 90% and a Tg of less than −100° C. may be used in the elastomer component. In certain embodiments, the only polybutadiene rubber used has a cis bond content of at least 92% (e.g., 92%, 93%, 94%, 95%, 96%, 97%, 98%, 99%, or more) and a Tg of less than −101° C. In preferred embodiments, the amount of any polybutadiene rubber having a high vinyl content (i.e., above about 70%) that is used in the elastomer component is limited to less than 25 parts, more preferably less than 10 parts, even more preferably less than 5 parts or 0 parts.

According to certain embodiments, when a polybutadiene rubber is used in the rubber composition, the amount utilized may vary. In certain embodiments, the total amount of any polybutadiene rubber present in the elastomer component will be 50% or less by weight. In such embodiments, the total amount of polybutadiene rubber present in the elastomer component is less than 50 phr, less than 40 phr, less than 30 phr, less than 20 phr, or less than 10 phr. In certain embodiments, the total amount of polybutadiene rubber present in the elastomer component is 1-50 phr, 1-40 phr, 1-30 phr, 5-50 phr, 5-40 phr, 5-30 phr, 5-20 phr, 5-10 phr, 10-50 phr, 10-40 phr, 10-30 phr, 10-20 phr, 20-50 phr, 20-40 phr, or 20-30 phr.

### Additional Rubber

In one or more embodiments, the elastomer component may further comprise an additional rubber, the additional rubber comprising styrene-butadiene copolymer rubber, styrene-isoprene rubber, butadiene-isoprene rubber, styrene-isoprene-butadiene rubber, butyl rubber (both halogenated and non-halogenated), ethylene-propylene rubber (EPR), ethylene-butylene rubber (EBR), ethylene-propylene-diene rubber (EPDM), and combinations thereof. For example, in one or more embodiments, the tire tread composition may further comprise SBR. In one or more embodiments, the amount of the additional rubber in the tire tread rubber composition may be from 1 phr to 25 phr. In one or more embodiments, the amount of the additional rubber may be greater than or equal to 1 phr, greater than or equal to 3 phr, greater than or equal to 5 phr, or even greater than or equal to 7 phr. In one or more embodiments, the amount of the additional rubber in the tire innerliner composition may be less than or equal to 25 phr, less than or equal to 20 phr, less than or equal to 15 phr, or even less than or equal to 10 phr. In one or more embodiments, the amount of the additional rubber in the tire innerliner composition may be from 1-25 phr, 1-20 phr, 1-15 phr, 1-10 phr, 3-25 phr, 3-20 phr, 3-15 phr, 3-10 phr, 5-25 phr, 5-20 phr, 5-15 phr, 5-10 phr, 7-25 phr, 7-20 phr, 7-15 phr, or even from 7-10 phr, or any and all sub-ranges formed from any of these endpoints.

### Styrene-Butadiene Copolymer Rubber

In one or more embodiments, the elastomer component of the tire tread composition may include styrene-butadiene copolymer rubber. In one or more embodiments, the styrene-butadiene copolymer rubber may be functionalized or non-functionalized. In one or more embodiments, one or more types of functional groups may be utilized for each SBR. Generally, a functional group may be present at the head of the polymer, at the tail of the polymer, along the backbone of the polymer chain, or a combination thereof. Functional groups present at one or both terminals of a polymer are generally the result of the use of a functional initiator, a functional terminator, or both. Alternatively or additionally, the functional group may be present as a result of coupling of multiple polymer chains using a coupling agent.

In one or more embodiments, the elastomer component may include at least one styrene-butadiene copolymer rubber that is functionalized. In one or more embodiments, the only styrene-butadiene copolymer rubber used in the elastomer component may be a styrene-butadiene copolymer rubber functionalized with a silica-reactive functional group. In other embodiments, the elastomer component may include at least one styrene-butadiene rubber which is not functionalized. In one or more embodiments, the non-functionalized styrene-butadiene rubber may be used in combination with a functionalized styrene-butadiene copolymer rubber (e.g., functionalized with a silica-reactive functional group). Non-limiting examples of silica-reactive functional groups generally include nitrogen-containing functional groups, silicon-containing functional groups, oxygen- or sulfur-containing functional groups, and metal-containing functional groups, as discussed in more detail below.

In one or more embodiments in which a functionalized SBR is used in the elastomer component, the functionalization may be achieved by adding a functional group to one or both terminus of the polymer, by adding a functional group to the backbone of the polymer (or a combination of the foregoing) or by coupling more than one polymer chains to a coupling agent, or by a combination thereof. In one or more embodiments, such effects may be achieved by treating a living polymer with coupling agents, functionalizing agents, or a combination thereof which serve to couple and/or functionalize other chains. In one or more embodiments, the functionalized SBR may contain one or more functional groups but may not be coupled (i.e., does not contain any coupling agents). Generally, a coupling agent and/or functionalizing agent can be used at various molar ratios. Alternatively, in other embodiments, the functionalized SBR may be silica-reactive merely from the result of using a coupling agent. Although reference is made herein to the use of both coupling agents and functionalizing groups (and compounds used therefor), those skilled in the art may appreciate that certain compounds may serve both functions. That is, certain compounds may both couple and provide the polymer chains with a functional group. Those skilled in the art may also appreciate that the ability to couple polymer chains may depend upon the amount of coupling agent reacted with the polymer chains. For example, advantageous coupling may be achieved where the coupling agent is added in a one to one ratio between the equivalents of lithium on the initiator and equivalents of leaving groups (e.g., halogen atoms) on the coupling agent. Non-limiting examples of coupling agents include metal halides, metalloid halides, alkoxysilanes, alkoxystannanes, and combinations thereof.

Non-limiting examples of nitrogen-containing functional groups that may be utilized in embodiments as a silica-reactive functional group in the SBR include, but are not limited to, a substituted or unsubstituted amino group, an amide residue, an isocyanate group, an imidazolyl group, an indolyl group, an imino group, a nitrile group, a pyridyl group, and a ketimine group. The foregoing substituted or unsubstituted amino group should be understood to include a primary alkylamine, a secondary alkylamine, or a cyclic amine, and an amino group derived from a substituted or unsubstituted imine. In one or more embodiments, the SBR of the elastomer component may comprise at least one silica-reactive functional group selected from the foregoing list of nitrogen-containing functional groups.

In one or more embodiments, the SBR may include a silica-reactive functional group from a compound which includes nitrogen in the form of an imino group. Such an imino-containing functional group may be added by reacting the active terminal of a polymer chain with a compound having the following formula (I):

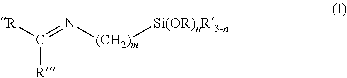

wherein R, R′, R″, and R′″ each independently are selected from a group having from 1 to 18 carbon atoms selected from the group consisting of an alkyl group, an allyl group, and an aryl group; m and n are integers from 1 to 20 and from 1 to 3, respectively. In one or more embodiments, each of R, R′, R″, and R′″ may be hydrocarbyl and contain no heteroatoms. In one or more embodiments, each R and R′ may be independently selected from an alkyl group having from 1 to 6 carbon atoms or even from 1 to 3 carbon atoms. In one or more embodiments, m may be an integer from 2 to 6 or even from 2 to 3. In one or more embodiments, R′″ may be selected from a group having from 1 to 6 carbon atoms or even from 2 to 4 carbon atoms. In one or more embodiments, R″ may be selected from an alkyl group having from 1 to 6 carbon atoms, from 1 to 3 carbon atoms, or even 1 carbon atom (e.g., methyl). In one or more embodiments, n may be 3, resulting in a compound with a trihydrocarboxysilane moiety such as a trialkoxysilane moiety. Non-limiting examples of compounds having an imino group and meeting formula (I) above, which are suitable for providing the silica-reactive functional group for the SBR include, but are not limited to, N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, and N-(4-N,N-dimethylaminobenzylidene)-3-(triethoxysilyl)-1-propaneamine.

Non-limiting examples of silicon-containing functional groups that may be utilized in embodiments as a silica-reactive functional group in the SBR include, but are not limited to, an organic silyl or siloxy group. For example, in one or more embodiments, a functional group may be selected from an alkoxysilyl group, an alkylhalosilyl group, a siloxy group, an alkylaminosilyl group, and an alkoxyhalosilyl group. In one or more embodiments, the organic silyl or siloxy group may also contain one or more nitrogens. Suitable silicon-containing functional groups for use in functionalizing diene-based elastomers may also include those disclosed in U.S. Pat. No. 6,369,167, the entire disclosure of which is herein incorporated by reference. In one or more embodiments, the SBR may comprise at least one silica-reactive functional group selected from the foregoing list of silicon-containing functional groups.

In other embodiments, the SBR may include a silica-reactive functional group which includes a silicon-containing functional group having a siloxy group (e.g., a hydrocarbyloxysilane-containing compound), wherein the compound optionally includes a monovalent group having at least one functional group. Such a silicon-containing functional group may be added by reacting the active terminal of a polymer chain with a compound having the following formula (II):

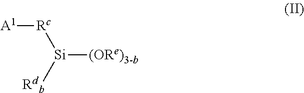

wherein A¹ represents a monovalent group having at least one functional group selected from epoxy, isocyanate, imine, cyano, carboxylic ester, carboxylic anhydride, cyclic tertiary amine, non-cyclic tertiary amine, pyridine, silazane and sulfide; R^{c} represents a single bond or a divalent hydrocarbon group having from 1 to 20 carbon atoms; R^{d} represents a monovalent aliphatic hydrocarbon group having from 1 to 20 carbon atoms, a monovalent aromatic hydrocarbon group having from 6 to 18 carbon atoms or a reactive group; R^{e} represents a monovalent aliphatic hydrocarbon group having from 1 to 20 carbon atoms or a monovalent aromatic hydrocarbon group having from 6 to 18 carbon atoms; b is an integer from 0 to 2; when more than one R^{d} or OR^{e} are present, each R^{d} and/or OR^{e} may be the same as or different from each other; and an active proton is not contained in a molecule) and/or a partial condensation product thereof. In one or more embodiments, at least one of the following is met: (a) R^{c} represents a divalent hydrocarbon group having from 1 to 12 carbon atoms, from 2 to 6 carbon atoms, or even from 2 to 3 carbon atoms; (b) R^{e} represents a monovalent aliphatic hydrocarbon group having from 1 to 12 carbon atoms, from 2 to 6 carbon atoms, or even from 1 to 2 carbon atoms or a monovalent aromatic hydrocarbon group having from 6 to 8 carbon atoms; (c) R^{d} represents a monovalent aliphatic hydrocarbon group having from 1 to 12 carbon atoms, from 2 to 6 carbon atoms, or even from 1 to 2 carbon atoms or a monovalent aromatic hydrocarbon group having from 6 to 8 carbon atoms; in certain such embodiments, each of (a), (b) and (c) are met and R^{c}, R^{e}, and R^{d} are selected from one of the foregoing groups.

In one or more embodiments, the functional group of the SBR may result from a compound represented by Formula (II) wherein A¹ has at least one epoxy group. Non-limiting specific examples of such compounds include 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, (3-glycidoxypropyl)-methyldimethoxysilane, 2-(3,4-epoxycyclohexyl)ethyltrimethoxysilane, 2-(3,4-epoxycyclohexyl)ethyltriethoxysilane, 2-(3,4-epoxycyclohexyl)ethyl(methyl)dimethoxysilane, and the like.

In other embodiments, the functional group of the SBR may result from a compound represented by Formula (II) wherein A¹ has at least one isocyanate group. Non-limiting specific examples of such compounds include 3-isocyanatopropyltrimethoxysilane, 3-isocyanatopropyltriethoxysilane, 3-isocyanatopropylmethyldiethoxysilane, 3-isocyanatopropyltriisopropoxysilane, and the like.

In other embodiments, the functional group of the SBR may result from a compound represented by Formula (II) wherein A¹ has at least one imine group. Non-limiting specific examples of such compounds include N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, N-(cyclohexylidene)-3-(triethoxysilyl)-1-propaneamine and trimethoxysilyl compounds, methyldiethoxysilyl compounds, ethyldimethoxysilyl compounds, and the like each corresponding to the above triethoxysilyl compounds. In one or more embodiments, the imine(amidine) group-containing compounds may include 1-[3-trimethoxysilyl]propyl]-4,5-dihydroimidazole, 3-(1-hexamethyleneimino)propyl(triethoxy)silane, (1-hexamethyleneimino)methyl(trimethoxy)silane, N-(3-triethoxysilylpropyl)-4,5-dihydroimidazole, N-(3-isopropoxysilylpropyl)-4,5-dihydroimidazole, N-(3-methyldiethoxysilylpropyl)-4,5-dihydroimidazole, and the like.

In other embodiments, the functional group of the SBR may result from a compound represented by Formula (II) wherein A¹ has at least one carboxylic ester group. Non-limiting specific examples of such compounds include 3-methacryloyloxypropyltriethoxysilane, 3-methacryloyloxypropyltrimethoxysilane, 3-methacryloyloxypropylmethyldiethoxysilane, 3-methacryloyloxypropyltriisopropoxysilane, and the like.

In other embodiments, the functional group of the SBR may result from a compound represented by Formula (II) wherein A¹ has at least one carboxylic anhydride group. Non-limiting specific examples of such compounds include 3-trimethoxysilylpropylsuccinic anhydride, 3-triethoxysilylpropylsuccinic anhydride, 3-methyldiethoxysilylpropylsuccinic anhydride, and the like.

In other embodiments, the functional group of the SBR may result from a compound represented by Formula (II) wherein A¹ has at least one cyano group. Non-limiting specific examples of such compounds include 2-cyanoethylpropyltriethoxysilane and the like.

In other embodiments, the functional group of the SBR may result from a compound represented by Formula (II) wherein A¹ has at least one cyclic tertiary amine group. Non-limiting specific examples of such compounds include 3-(1-hexamethyleneimino)propyltriethoxysilane, 3-(1-hexamethyleneimino)propyltrimethoxysilane, (1-hexamethyleneimino)methyltriethoxysilane, (1-hexamethyleneimino)methyltrimethoxysilane, 2-(1-hexamethyleneimino)ethyltriethoxysilane, 3-(1-hexamethyleneimino)ethyltrimethoxysilane, 3-(1-pyrrolidinyl)propyltrimethoxysilane, 3-(1-pyrrolidinyl)propyltriethoxysilane, 3-(1-heptamethyleneimino)propyltriethoxysilane, 3-(1-dodecamethyleneimino)propyltriethoxysilane, 3-(1-hexamethyleneimino)propyldiethoxymethylsilane, 3-(1-hexamethyleneimino)propyldiethoxyethylsilane, 3-[10-(triethoxysilyl)decyl]-4-oxazoline and the like.

In other embodiments, the functional group of the SBR may result from a compound represented by Formula (II) wherein A¹ has at least one non-cyclic tertiary amine group. Non-limiting specific examples of such compounds include 3-dimethylaminopropyltriethoxysilane, 3-dimethylaminopropyltrimethoxysilane, 3-diethylaminopropyltriethoxysilane, 3-dimethylaminopropyltrimethoxysilane, 2-dimethylaminoethyltriethoxysilane, 2-dimethylaminoethyltrimethoxysilane, 3-dimethylaminopropyldiethoxymethylsilane, 3-dibutylaminopropyltriethoxysilane, and the like.

In other embodiments, the functional group of the SBR may result from a compound represented by Formula (II) wherein A¹ has at least one pyridine group. Non-limiting specific examples of such compounds include 2-trimethoxysilylethylpyridine, and the like.

In other embodiments, the functional group of the SBR may result from a compound represented by Formula (II) wherein A¹ has at least one silazane group. Non-limiting specific examples of such compounds include N,N-bis(trimethylsilyl)-aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethyltriethoxysilane, N,N-bis(trimethylsilyl)aminoethylmethyldimethoxysilane, N,N-bis(trimethylsilyl)aminoethylmethyldiethoxysilane, and the like.

In one or more embodiments wherein a silica-reactive functional group according to Formula (II) is used wherein A¹ contains one or more protected nitrogens (as discussed in detail above), the nitrogen(s) may be deprotected or deblocked by hydrolysis or other procedures to convert the protected nitrogen(s) into a primary nitrogen. As a non-limiting example, a nitrogen bonded to two trimethylsilyl groups could be deprotected and converted to a primary amine nitrogen (such a nitrogen would still be bonded to the remainder of the formula (II) compound). Accordingly, in embodiments wherein a silica-reactive functional group of the SBR results from use of a compound according to Formula (II) wherein A¹ contains one or more protected nitrogens, the functionalized polymer may be understood as containing a functional group resulting from a deprotected (or hydrolyzed) version of the compound.

Non-limiting examples of oxygen- or sulfur-containing functional groups that may be utilized in embodiments as a silica-reactive functional group in the SBR include, but are not limited to, a hydroxyl group, a carboxyl group, an epoxy group, a glycidoxy group, a diglycidylamino group, a cyclic dithiane-derived functional group, an estergroup, an aldehyde group, an alkoxy group, a ketone group, a thiocarboxyl group, a thioepoxy group, a thioglycidoxy group, a thiodiglycidylamino group, a thioester group, a thioaldehyde group, a thioalkoxy group, and a thioketone group. In one or more embodiments, the foregoing alkoxy group may be an alcohol-derived alkoxy group derived from a benzophenone. In other embodiments, the SBR may comprise at least silica-reactive functional group selected from the foregoing list of oxygen- or sulfur-containing functional groups.

In one or more embodiments, the SBRs having a silica-reactive functional group may be prepared by either solution polymerization or by emulsion polymerization. In one or more embodiments, the only SBR or SBR having a silica-reactive functional group may be prepared by solution polymerization. In other embodiments, the only SBR or SBR having a silica-reactive functional group may be prepared by emulsion polymerization. In embodiments, when more than one SBR or SBR having a silica-reactive functional group is used, the rubbers may be a combination of solution polymerized SBR and emulsion polymerized SBR (e.g., one solution SBR and one emulsion SBR). In other embodiments, the only SBR(s) present in the elastomer component (including for the SBR having a silica-reactive functional group) may be a solution SBR (i.e., no emulsion SBR is present).

In one or more embodiments, the coupling agent for the SBR comprises a metal halide or metalloid halide selected from the group comprising compounds expressed by the formula (1) R*ₙM¹Y₍₄₋ₙ₎, the formula (2) M¹Y₄, and the formula (3) M²Y₃, where each R* is independently a monovalent organic group having 1 to 20 carbon atoms, M¹ is a tin atom, silicon atom, or germanium atom, M² is a phosphorous atom, Y is a halogen atom, and n is an integer of 0-3.

Exemplary compounds expressed by the formula (1) include halogenated organic metal compounds, and the compounds expressed by the formulas (2) and (3) include halogenated metal compounds.

In one or more embodiments where M¹ represents a tin atom, the compounds expressed by the formula (1) may be, for example, triphenyltin chloride, tributyltin chloride, triisopropyltin chloride, trihexyltin chloride, trioctyltin chloride, diphenyltin dichloride, dibutyltin dichloride, dihexyltin dichloride, dioctyltin dichloride, phenyltin trichloride, butyltin trichloride, octyltin trichloride, and the like. Furthermore, tin tetrachloride, tin tetrabromide, and the like may be exemplified as the compounds expressed by formula (2).

In other embodiments where M¹ represents a silicon atom, the compounds expressed by the formula (1) may be, for example, triphenylchlorosilane, trihexylchlorosilane, trioctylchlorosilane, tributylchlorosilane, trimethylchlorosilane, diphenyldichlorosilane, dihexyldichlorosilane, dioctyldichlorosilane, dibutyldichlorosilane, dimethyldichlorosilane, methyltrichlorosilane, phenyltrichlorosilane, hexyltrichlorosilane, octyltrichlorosilane, butyltrichlorosilane, methyltrichlorosilane, and the like. Furthermore, silicon tetrachloride, silicon tetrabromide and the like may be exemplified as the compounds expressed by the formula (2).

In other embodiments where M¹ represents a germanium atom, the compounds expressed by the formula (1) may be, for example, triphenylgermanium chloride, dibutylgermanium dichloride, diphenylgermanium dichloride, butylgermanium trichloride and the like. Furthermore, germanium tetrachloride, germanium tetrabromide, and the like can be exemplified as the compounds expressed by the formula (2). Phosphorous trichloride, phosphorous tribromide and, the like may be exemplified as the compounds expressed by the formula (3). In embodiments, mixtures of metal halides and/or metalloid halides may be used.

In one or more embodiments, the coupling agent for the SBR may comprise an alkoxysilane or alkoxystannane selected from the group comprising compounds expressed by the formula (4) R*ₙM¹(OR )₄₋ₙ, where each R* is independently a monovalent organic group having from 1 to 20 carbon atoms, M¹ is a tin atom, silicon atom, or germanium atom, OR\hat{ } is an alkoxy group where R\hat{ } is a monovalent organic group, and n is an integer from 0 to 3.

Exemplary compounds expressed by the formula (4) include tetraethyl orthosilicate, tetramethyl orthosilicate, tetrapropyl orthosilicate, tetraethoxy tin, tetramethoxy tin, and tetrapropoxy tin.

In one or more embodiments, the SBR may have a Mw greater than or equal to 300,000 g/mol; greater than or equal to 325,000 g/mol; greater than or equal to 350,000 g/mol; greater than or equal to 375,000 g/mol; greater than or equal to 400,000 g/mol; or even greater than or equal to 425,000 g/mol. In one or more embodiments, the SBR may have a Mw less than or equal to 600,000 g/mol; less than or equal to 575,000 g/mol; less than or equal to 550,000 g/mol; less than or equal to 525,000 g/mol; less than or equal to 500,000 g/mol; less than or equal to 475,000 g/mol; or even less than or equal to 450,000 g/mol. In one or more embodiments, the SBR may have a Mw from 300,000 g/mol to 600,000 g/mol; from 300,000 g/mol to 575,000 g/mol; from 300,000 g/mol to 550,000 g/mol; from 300,000 g/mol to 525,000 g/mol; from 300,000 g/mol to 500,000 g/mol; from 300,000 g/mol to 475,000 g/mol; from 300,000 g/mol to 450,000 g/mol; from 325,000 g/mol to 600,000 g/mol; from 325,000 g/mol to 575,000 g/mol; from 325,000 g/mol to 550,000 g/mol; from 325,000 g/mol to 525,000 g/mol; from 325,000 g/mol to 500,000 g/mol; from 325,000 g/mol to 475,000 g/mol; from 325,000 g/mol to 450,000 g/mol; from 350,000 g/mol to 600,000 g/mol; from 350,000 g/mol to 575,000 g/mol; from 350,000 g/mol to 550,000 g/mol; from 350,000 g/mol to 525,000 g/mol; from 350,000 g/mol to 500,000 g/mol; from 350,000 g/mol to 475,000 g/mol; from 350,000 g/mol to 450,000 g/mol; from 375,000 g/mol to 600,000 g/mol; from 375,000 g/mol to 575,000 g/mol; from 375,000 g/mol to 550,000 g/mol; from 375,000 g/mol to 525,000 g/mol; from 375,000 g/mol to 500,000 g/mol; from 375,000 g/mol to 475,000 g/mol; from 375,000 g/mol to 450,000 g/mol; from 400,000 g/mol to 600,000 g/mol; from 400,000 g/mol to 575,000 g/mol; from 400,000 g/mol to 550,000 g/mol; from 400,000 g/mol to 525,000 g/mol; from 400,000 g/mol to 500,000 g/mol; from 400,000 g/mol to 475,000 g/mol; from 400,000 g/mol to 450,000 g/mol; from 425,000 g/mol to 600,000 g/mol; from 425,000 g/mol to 575,000 g/mol; from 425,000 g/mol to 550,000 g/mol; from 425,000 g/mol to 525,000 g/mol; from 425,000 g/mol to 500,000 g/mol; from 425,000 g/mol to 475,000 g/mol; or even from 425,000 g/mol to 450,000 g/mol; or any and all sub-ranges formed from any of these endpoints.

In one or more embodiments, the SBR may have a Mn greater than or equal to 200,000 g/mol; greater than or equal to 225,000 g/mol; greater than or equal to 250,000 g/mol; or even greater than or equal to 275,000 g/mol. In one or more embodiments, the SBR may have a Mn less than or equal to 400,000 g/mol; less than or equal to 375,000 g/mol; less than or equal to 350,000 g/mol; less than or equal to 325,000 g/mol; or even less than or equal to 300,000 g/mol. In one or more embodiments, the SBR may have a Mn from 200,000 g/mol to 400,000 g/mol; from 200,000 g/mol to 375,000 g/mol; from 200,000 g/mol to 350,000 g/mol; from 200,000 g/mol to 325,000 g/mol; from 200,000 g/mol to 300,000 g/mol; from 225,000 g/mol to 400,000 g/mol; from 225,000 g/mol to 375,000 g/mol; from 225,000 g/mol to 350,000 g/mol; from 225,000 g/mol to 325,000 g/mol; from 225,000 g/mol to 300,000 g/mol; from 250,000 g/mol to 400,000 g/mol; from 250,000 g/mol to 375,000 g/mol; from 250,000 g/mol to 350,000 g/mol; from 250,000 g/mol to 325,000 g/mol; from 250,000 g/mol to 300,000 g/mol; from 275,000 g/mol to 400,000 g/mol; from 275,000 g/mol to 375,000 g/mol; from 275,000 g/mol to 350,000 g/mol; from 275,000 g/mol to 325,000 g/mol; or even from 275,000 g/mol to 300,000 g/mol; or any and all sub-ranges formed from any of these endpoints.

In one or more embodiments, the SBR may have a Mw/Mn (polydispersity) greater than or equal to 1.2, greater than or equal to 1.3, greater than or equal to 1.4, greater than or equal to 1.5, or even greater than or equal to 1.6. In one or more embodiments, the SBR may have a Mw/Mn less than or equal to 2.5, less than or equal to 2.4, less than or equal to 2.3, less than or equal to 2.2, less than or equal to 2.1, or even less than or equal to 2. In one or more embodiments, the SBR may have a Mw/Mn from 1.2 to 2.5, from 1.2 to 2.4, from 1.2 to 2.3, from 1.2 to 2.2, from 1.2 to 2.1, from 1.2 to 2, from 1.3 to 2.5, from 1.3 to 2.4, from 1.3 to 2.3, from 1.3 to 2.2, from 1.3 to 2.1, from 1.3 to 2, from 1.4 to 2.5, from 1.4 to 2.4, from 1.4 to 2.3, from 1.4 to 2.2, from 1.4 to 2.1, from 1.4 to 2, from 1.5 to 2.5, from 1.5 to 2.4, from 1.5 to 2.3, from 1.5 to 2.2, from 1.5 to 2.1, from 1.5 to 2, from 1.6 to 2.5, from 1.6 to 2.4, from 1.6 to 2.3, from 1.6 to 2.2, from 1.6 to 2.1, or even from 1.6 to 2, or any and all sub-ranges formed from any of these endpoints.

In one or more embodiments, the SBR may have a Tg greater than or equal to −75° C., greater than or equal to −65° C., or even greater than or equal to −55° C. In one or more embodiments, the SBR may have a Tg less than or equal to −10° C., less than or equal to −20° C., less than or equal to −30° C., or even less than or equal to −40° C. In one or more embodiments, the SBR may have a Tg from −75° C. to −10° C., from −75° C. to −20° C., from −75° C. to −30° C., from −75° C. to −40° C., from −65° C. to −10° C., from −65° C. to −20° C., from −65° C. to −30° C., from −65° C. to −40° C., from −55° C. to −10° C., from −55° C. to −20° C., from −55° C. to −30° C., or even from −55° C. to −40° C., or any and all sub-ranges formed from any of these endpoints.

In one or more embodiments, the SBR may have a styrene monomer content greater than or equal to 10 wt % or even greater than or equal to 15 wt %. In one or more embodiments, the SBR may have a styrene monomer content less than or equal to 40 wt %, less than or equal to 30 wt %, less than or equal to 25 wt %, or even less than or equal to 20 wt %. In one or more embodiments, the SBR may have a styrene monomer content from 10 wt % to 40 wt %, from 10 wt % to 30 wt %, from 10 wt % to 25 wt %, from 10 wt % to 20 wt %, from 15 wt % to 40 wt %, from 15 wt % to 30 wt %, from 15 wt % to 25 wt %, or even from 15 wt % to 20 wt %, or any and all sub-ranges formed from any of these endpoints.

In one or more embodiments, the SBR may have a vinyl bond content greater than or equal to 10%, greater than or equal to 15%, greater than or equal to 20%, or even greater than or equal to 25%. In one or more embodiments, the SBR may have a vinyl bond content less than or equal to 50%, less than or equal to 45%, less than or equal to 40%, or even less than or equal to 35%. In one or more embodiments, the SBR may have a vinyl bond content from 10% to 50%, from 10% to 45%, from 10% to 40%, from 10% to 35%, from 15% to 50%, from 15% to 45%, from 15% to 40%, from 15% to 35%, from 20% to 50%, from 20% to 45%, from 20% to 40%, from 20% to 35%, from 25% to 50%, from 25% to 45%, from 25% to 40%, or even from 25% to 35%, or any and all sub-ranges formed from any of these endpoints.

### DCPD-Based Resin

According to certain embodiments, the tread rubber composition includes a DCPD-based resin. DCPD refers to dicyclopentadiene. Generally, the DCPD-based resin may be a DCPD homopolymer resin or a DCPD copolymer resin. By the phrase DCPD-based is meant that the resin contains a proportion of DCPD as monomer, more specifically at least 15% by weight (e.g., 15, 25, 30, 35, 40, 45, 50, 55, 60, 65, 70, 75%, etc.), at least 20% by weight (e.g., 30%, 40%, 50%, 60%, 70%, 80%, 90%, 95%, or 100% by weight), at least 25% by weight (e.g., 25%, 30%, 35%, etc.), at least 30% by weight (e.g., 30%, 40%, etc.), at least 40% by weight (e.g., 40%, 50%, 60%, 70%, 80%, 90%, 95%, or 100% by weight), at least 50% by weight (e.g., 50%, 60%, 70%, 80%, 90%, 95%, or 100% by weight), or more. In certain embodiments, the DCPD-based resin comprises a majority by weight of DCPD as monomer, e.g., at least 51%, at least 60%, at least 70%, at least 80%, at least 90%, at least 95%, or even 100% by weight); in certain such embodiments, the DCPD-based resin can be considered to be a relatively pure DCPD resin, especially when the percentage by weight of DCPD monomer at least 80% (e.g., 80%, 81%, 82%, 83%, 84%, 85%, 86%, 87%, 88%, 89%, 90%, 91%, 92%, 93%, 94%, 95%, 96%, 97%, 98%, or more), at least 90% (e.g., 90%, 91%, 92%, 93%, 94%, 95%, 96%, 97%, 98%, or more), or more. In other embodiments of the DCPD-based resin comprises a minority by weight of DCPD as monomer, e.g., no more than 49% (e.g., 49%, 45%, 40%, 35%, 30%, 25%, 20%, or less), no more than 40% (e.g., 40%, 35%, 30%, 25%, 20%, or less), no more than 30% (e.g., 30%, 25%, 20%, or less), no more than 20% (e.g., 20%, 19%, 18%, etc.), or any amount within one of the foregoing amounts, e.g., 49-20%, 40-20%, 30-20%, etc.

According to certain embodiments, the amount of DCPD-based resin that is present in the rubber composition for the tire tread may vary but generally will be at least 5 phr and up to 40 phr. In certain embodiments, the amount of DCPD-based resin used in the resin component is 5-40 phr, 5-30 phr, 5-25 phr, 5-20 phr, 5-15 phr, 10-40 phr, 15-40 phr, 20-40 phr, 5-30 phr, 10-30 phr, 15-30 phr, or 20-30 phr.

In certain embodiments, the DCPD-based resin is hydrogenated. In such embodiments, the amount of hydrogenation may vary. In certain embodiments, the hydrogenated DCPD-based resin has a degree of hydrogenation of at least 50%, at least 60%, at least 70%, or more. In certain embodiments, the hydrogenated DCPD-based resin has a degree of hydrogenation of 50-90%, 50-80%, 50-70%, 60-90%, 60-80%, or 60-70%.

DCPD-based resins suitable for use in certain embodiments are commercially available from various suppliers. As non-limiting examples, DCPD-based resins for use in certain embodiments are available from companies such as Neville Chemical Company (Pittsburgh, Pennsylvania) under their LX® brand, Resinall Corporation (Sovern, North Carolina), The Dow Chemical Company, and Zeon Corporation of Japan (doing business in the United States as Zeon Chemicals LP) under their Quintone® brand).

According to certain embodiments, the Tg and softening point of the DCPD-based resin may vary. In certain embodiments, the DCPD-based resin has a Tg of about 35 to about 110° C. or 35-110° C. (e.g., 35, 40, 45, 50, 55, 60, 65, 70, 75, 80, 85, 90, 95, 100, 105, or 110° C.). In certain of these embodiments, the DCPD-based resin has a softening point of about 90 to about 160° C. or 90-160° C. (e.g., 90, 95, 100, 105, 110, 115, 120, 125, 130, 135, 140, 145, 150, 155, or 160° C.). In certain preferred embodiments, the DCPD-based resin has both a Tg and a softening point with the foregoing ranges.

In certain embodiments, the DCPD-based resin has at least one of a Tg and a softening point at the lower end of above broadest ranges. For example, in such embodiments, the DCPD-based resin may have a Tg of about 35 to about 60° C. or 35-60° C. (e.g., 35, 36, 38, 40, 42, 44, 45, 46, 48, 50, 52, 54, 55, 56, 58, or 60° C.), or preferably about 40 to about 55° C., or 40-55° C. (e.g., 40, 42, 44, 45, 46, 48, 50, 52, 54, or 55° C.). In certain embodiments, the DCPD-based resin has a softening point of about 90 to about 120° C., 90-120° C. (e.g., 90, 95, 100, 105, 110, 115, or 120° C.); preferably about 95 to about 115° C. or 95-115° C. (e.g., 95, 100, 105, 110, or 115° C.); or about 95 to about 110° C. or 95-110° C. (e.g., 95, 100, 105 or 110° C.).

In other embodiments, the DCPD-based resin has at least one of a Tg and a softening point at the upper end of the above broadest ranges. For example, in such embodiments, the DCPD-based resin may have a Tg of about 70 to about 110° C. or 70-110° C. (e.g., 70, 75, 80, 85, 90, 95, 100, 105, or 110° C.); preferably about 75 to about 105° C. or 75-105° C. (e.g., 75, 80, 85, 90, 95, 100 or 105° C.), or more preferably 80-100° C. (e.g., 80, 82, 84, 85, 86, 88, 90, 92, 94, 95, 96, 98, or 100° C.). In certain embodiments, the DCPD-based resin has a softening point of about 120 to about 160° C. or 120-160° C. (e.g., 120, 125, 130, 135, 140, 145, 150, 155, or 160° C.), preferably about 130 to about 150° C. or 130-150° C. (e.g., 130, 135, 140, 145, or 150° C.). In certain preferred embodiments of, the DCPD-based resin has both a Tg and a softening point with the foregoing ranges.

According to certain embodiments, the Mw, Mn and Mw/Mn of the DCPD-based resin may vary. In certain embodiments, the DCPD-based resin meets at least one of the following: (a) a Mw of about 1000 to about 4000 grams/mole, 1000-4000 grams/mole (e.g., 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or 4000 grams/mole), about 1000 to about 3000 grams/mole, 1000-3000 grams/mole (e.g., (e.g., 1000, 1100, 1200, 1300, 1400, 1500, 1600, 1700, 1800, 1900, 2000, 2100, 2200, 2300, 2400, 2500, 2600, 2700, 2800, 2900, or 3000 grams/mole), about 1000 to about 2500 grams/mole, 1000-2500 grams/mole (e.g., 1000, 1100, 1200, 1300, 1400, 1500, 1600, 1700, 1800, 1900, 2000, 2100, 2200, 2300, 2400, or 2500 grams/mole), about 1100 to about 2000 grams/mole, or 1100-2000 grams/mole (e.g., 1100, 1200, 1300, 1400, 1500, 1600, 1700, 1800, 1900, or 2000 grams/mole); (b) a Mn of about 700 to about 1500 grams/mole, 700-1500 grams/mole (e.g., 700, 800, 900, 1000, 1100, 1200, 1300, 1400, or 1500 grams/mole), about 800 to about 1400 grams/mole, 800-1400 grams/mole (e.g., 800, 900, 1000, 1100, 1200, 1300, or 1400 grams/mole), about 800 to about 1300 grams/mole, 800-1300 grams/mole (e.g., 800, 900, 1000, 1100, 1200, or 1300 grams/mole), about 900 to about 1200 grams/mole, or 900-1200 grams/mole (e.g., 900, 950, 1000, 1050, 1100, 1150, or 1200 grams/mole); or (c) a polydispersity (Mw/Mn) of about 1 to about 2.5, 1-2.5 (e.g., 1, 1.1, 1.2, 1.3, 1.4, 1.5, 1.6, 1.7, 1.8, 1.9, 2, 2.1, 2.2, 2.3, 2.4, or 2.5), about 1.1 to about 2.2, 1.1-2.2 (e.g., 1.1, 1.2, 1.3, 1.4, 1.5, 1.6, 1.7, 1.8, 1.9, 2, 2.1, or 2.2), about 1.1 to about 2, 1.1-2 (e.g., 1.1, 1.2, 1.3, 1.4, 1.5, 1.6, 1.7, 1.8, 1.9, or 2), about 1.2 to about 2, or 1.2 to 2 (e.g., 1.2, 1.3, 1.4, 1.5, 1.6, 1.7, 1.8, 1.9, or 2). In certain embodiments, the DCPD-based resin has a Mw according to one of the ranges provided above, in combination with a Mn according to one of the ranges provided above, further in combination with a Mw/Mn according to one of the ranges provided above.

### Other Resin

In one or more embodiments, the rubber composition comprises one or more additional hydrocarbon resins other than DCPD-based resins, that may be solids with a Tg of greater than about 20° C., and may include, but are not limited to, hydrocarbon resins such as cycloaliphatic resins, aliphatic resins, aromatic resins, naphthenic resins, terpene resins, and combinations thereof. Useful resins include, but are not limited to, styrene-alkylene block copolymers, thermoplastic resins such as C5-based resins, C5-C9-based resins, C9-based resins, terpene-based resins, terpene-aromatic compound-based resins, rosin-based resins, alkylphenol-based resins, and their partially hydrogenated resins. In certain embodiments, the hydrocarbon resin comprises an aromatic resin optionally in combination with one or more additional resins selected from aliphatic, cycloaliphatic, naphthenic and terpene resins. In certain embodiments, the hydrocarbon resin excludes any terpene resin (i.e., 0 phr of terpene resin is present in the tread rubber composition). In certain embodiments, the hydrocarbon resin has a softening point of about 60 to about 130° C., alternatively about 70 to about 120° C., and preferably about 80 to about 110° C. In certain embodiments of, the hydrocarbon resin meets at least one of the following: (a) a Mw of 1000 to about 4000 grams/mole, 1000-4000 grams/mole, about 1000 to about 3000 grams/mole, 1000-3000 grams/mole, about 1000 to about 2500 grams/mole, 1000-2500 grams/mole, about 1000 to about 2000 grams/mole, 1000-2000 grams/mole, about 1100 to about 1800 grams/mole, or 1100-1800 grams/mole; (b) a Mn of about 700 to about 1500 grams/mole, 700-1500 grams/mole, about 800 to about 1400 grams/mole, 800-1400 grams/mole, about 800 to about 1300 grams/mole, 800-1300 grams/mole, about 900 to about 1200 grams/mole, or 900-1200 grams/mole; or (c) a polydispersity (Mw/Mn) of about 1 to about 2, 1-2, about 1.1 to about 1.8, 1.1-1.8, about 1.1 to about 1.7, 1.1-1.7, about 1.2 to about 1.5, or 1.2 to 1.5. In certain embodiments, the hydrocarbon resin has a Mw according to one of the ranges provided above, in combination with a Mn according to one of the ranges provided above, further in combination with a Mw/Mn according to one of the ranges provided above. In certain embodiments, the amount of hydrocarbon resin excluding DCPD-based resin present in the rubber composition is less than 30 phr, less than 25 phr, less than 20 phr, less than 15 phr, or less than 10 phr. In other embodiments, the amount of resin is 0-30 phr, 0-20 phr, 0-15 phr, 0-10 phr, 1-30 phr, 1-20 phr, 1-15 phr, 1-10 phr, 1-5 phr, 5-30 phr, 5-20 phr, 5-15 phr, 10-30 phr, 10-25 phr, or 10-20 phr.

### Filler Component

As mentioned above, in certain preferred embodiments the rubber composition for the tire tread includes a carbon black filler in an amount of from 10 to 50 phr and 20-70 phr of a reinforcing silica filler. In certain particularly preferred embodiments, the filler component comprises reinforcing silica filler and carbon black filler with the foregoing preferred amounts. In certain embodiments, the filler component is limited to (i.e., consists of or contains only) the reinforcing silica filler and carbon blackfiller in the foregoing discussed amounts. In other embodiments, the filler component includes not only the reinforcing silica filler and carbon black filler in the foregoing discussed amounts but also one or more reinforcing or non-reinforcing fillers, as discussed in more detail below.

### Reinforcing Silica Filler

As mentioned above, according to certain embodiments, the reinforcing silica filler in present in an amount of 20-70 phr (e.g., 21, 23, 25, 27, 29, 30, 32, 34, 35, 36, 38, 40, 42, 44, 45, 46, 48, 50, 52, 54, 55, 56, 58, 60, 62, 64, 65, 66, 68, or 70 phr). In certain embodiments, the reinforcing silica filler is present in an amount of 20-60 phr, 20-50 phr, 20-40 phr, 30-50 phr, 30-60 phr, 30-70 phr, 35-65 phr, 35-60 phr, 35-55 phr, or 40-50 phr.

According to certain embodiments, the surface area of the reinforcing silica filler may vary. According to certain embodiments, the particular type of silica for the at least one reinforcing silica filler may vary. Non-limiting examples of reinforcing silica fillers suitable for use in certain embodiments include, but are not limited to, precipitated amorphous silica, wet silica (hydrated silicic acid), dry silica (anhydrous silicic acid), fumed silica, calcium silicate and the like. Among the listed reinforcing silica fillers, precipitated amorphous wet-process, hydrated silica fillers are preferred. Such reinforcing silica fillers are produced by a chemical reaction in water, from which they are precipitated as ultrafine, spherical particles, with primary particles strongly associated into aggregates, which in turn combine less strongly into agglomerates. The surface area, as measured by the BET method, is a preferred measurement for characterizing the reinforcing character of different reinforcing silica fillers. In certain embodiments disclosed herein, the rubber composition comprises a reinforcing silica filler having a surface area (as measured by the BET method) of about 100 m²/g to about 400 m²/g, 100 m²/g to 400 m²/g (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 m²/g), about 100 m²/g to about 350 m²/g, or 100 m²/g to 350 m²/g (e.g., 100, 110, 120, 130, 140, 150, 160, 170, 180, 190, 200, 210, 220, 230, 240, 250, 260, 270, 280, 290, 300, 310, 320, 330, 340, or 350 m²/g). In certain embodiments disclosed herein, the rubber composition comprises a reinforcing silica filler having a BET surface area of about 140 m²/g to about 230 m²/g, 140 m²/g to 230 m²/g (e.g., 140, 150, 160, 170, 180, 190, 200, 210, 220, or 230 m²/g), with the ranges of about 170 m²/g to about 230 m²/g and 170 m²/g to 230 m²/g (e.g., 170, 180, 190, 200, 210, 220, or 230 m²/g) being included; in certain such embodiments the only silica filler present in the rubber composition has a BET surface area within one of the foregoing ranges. In other embodiments disclosed herein, the rubber composition comprises a reinforcing silica filler having a BET surface of about 100 m²/g to about 140 m²/g, 100 m²/g to 140 m²/g (e.g., 100, 105, 110, 115, 120, 125, 130, 135, or 140 m²/g), about 100 m²/g to about 125 m²/g, 100 m²/g to 125 m²/g (e.g., 100, 105, 110, 115, 120, or 125 m²/g), about 100 m²/g to about 120 m²/g, or 100 to 120 m²/g (e.g., 100, 105, 110, 115, or 120 m²/g); in certain such embodiments the only silica filler present in the rubber composition has a BET surface area within one of the foregoing ranges. In certain embodiments disclosed herein, the rubber composition comprises reinforcing silica filler having a pH of about 5.5 to about 8, 5.5 to 8 (e.g., 5.5, 5.7, 5.9, 6.1, 6.3, 6.5, 6.7, 6.9, 7.1, 7.3, 7.5, 7.7, 7.9, or 8), about 6 to about 8, 6 to 8 (e.g., 6, 6.2, 6.4, 6.6, 6.8, 7, 7.2, 7.4, 7.6, 7.8, or 8), about 6 to about 7.5, 6 to 7.5, about 6.5 to about 8, 6.5 to 8, about 6.5 to about 7.5, 6.5 to 7.5, about 5.5 to about 6.8, or 5.5 to 6.8. Some of the commercially available reinforcing silica fillers which can be used in certain embodiments include, but are not limited to, Hi-Sil® EZ120G, Hi-Sil® EZ120G-D, Hi-Sil® 134G, Hi-Sil®EZ 160G, Hi-Sil®EZ 160G-D, Hi-Sil®190, Hi-Sil®190G-D, Hi-Sil® EZ 200G, Hi-Sil® EZ 200G-D, Hi-Sil® 210, Hi-Sil® 233, Hi-Sil® 243LD, Hi-Sil® 255CG-D, Hi-Sil® 315-D, Hi-Sil® 315G-D, Hi-Sil® HDP 320G and the like, produced by PPG Industries (Pittsburgh, Pa.) As well, a number of useful commercial grades of different reinforcing silica fillers are also available from Evonik Corporation (e.g., Ultrasil® 320 GR, Ultrasil® 5000 GR, Ultrasil® 5500 GR, Ultrasil® 7000 GR, Ultrasil® VN2 GR, Ultrasil® VN2, Ultrasil® VN3, Ultrasil® VN3 GR, Ultrasil©7000 GR, Ultrasil® 7005, Ultrasil® 7500 GR, Ultrasil® 7800 GR, Ultrasil® 9500 GR, Ultrasil® 9000 G, Ultrasil® 9100 GR), and Solvay (e.g., Zeosil® 1115MP, Zeosil® 1085GR, Zeosil® 1165MP, Zeosil® 1200MP, Zeosil® Premium, Zeosil® 195HR, Zeosil® 195GR, Zeosil® 185GR, Zeosil® 175GR, and Zeosil® 165 GR).

### Silica Coupling Agent

In certain embodiments disclosed herein, one or more than one silica coupling agent may also (optionally) be utilized. In preferred embodiments, at least one silica coupling agent is utilized. Silica coupling agents are useful in preventing or reducing aggregation of the silica filler in rubber compositions. Aggregates of the silica filler particles are believed to increase the viscosity of a rubber composition, and, therefore, preventing this aggregation reduces the viscosity and improves the processability and blending of the rubber composition.

Generally, any conventional type of silica coupling agent can be used, such as those having a silane and a constituent component or moiety that can react with a polymer, particularly a vulcanizable polymer. The silica coupling agent acts as a connecting bridge between silica and the polymer. Suitable silica coupling agents for use in certain embodiments disclosed herein include those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the rubber composition in the form of a pre-treated silica; a pre-treated silica has been pre-surface treated with a silane prior to being added to the rubber composition. The use of a pre-treated silica can allow for two ingredients (i.e., silica and a silica coupling agent) to be added in one ingredient, which generally tends to make rubber compounding easier.

Alkyl alkoxysilanes have the general formula R¹⁰ₚSi(OR¹¹)₄₋ₚ where each R¹¹ is independently a monovalent organic group, and p is an integer from 1 to 3, with the proviso that at least one R¹⁰ is an alkyl group. Preferably p is 1. Generally, each R¹⁰ independently comprises C₁ to C₂₀ aliphatic, C₅ to C₂₀ cycloaliphatic, or C₆ to C₂₀ aromatic; and each R″ independently comprises C₁ to C₆ aliphatic. In certain exemplary embodiments, each R¹⁰ independently comprises C₆ to C₁₅ aliphatic and in additional embodiments each R¹⁰ independently comprises C₈ to C₁₄ aliphatic. Mercapto silanes have the general formula HS-R¹³—Si(R¹⁴)(R¹⁵)₂ where R¹³ is a divalent organicgroup, R¹⁴ is a halogen atom or an alkoxygroup, each R¹⁵ is independently a halogen, an alkoxy group or a monovalent organic group. The halogen is chlorine, bromine, fluorine, or iodine. The alkoxy group preferably has 1-3 carbon atoms. Blocked mercapto silanes have the general formula B—S—R¹⁶—Si—X₃ with an available silyl group for reaction with silica in a silica-silane reaction and a blocking group B that replaces the mercapto hydrogen atom to block the reaction of the sulfur atom with the polymer. In the foregoing general formula, B is a block group which can be in the form of an unsaturated heteroatom or carbon bound directly to sulfur via a single bond; R¹⁶ is C₁ to C₆ linear or branched alkylidene and each X is independently selected from the group consisting of C₁ to C₄ alkyl or C₁ to C₄ alkoxy.

Non-limiting examples of alkyl alkoxysilanes suitable for use in certain embodiments include, but are not limited to, octyltriethoxysilane, octyltrimethoxysilane, trimethylethoxysilane, cyclohexyltriethoxysilane, isobutyltriethoxy-silane, ethyltrimethoxysilane, cyclohexyl-tributoxysilane, dimethyldiethoxysilane, methyltriethoxysilane, propyltriethoxysilane, hexyltriethoxysilane, heptyltriethoxysilane, nonyltriethoxysilane, decyltriethoxysilane, dodecyltriethoxysilane, tetradecyltriethoxysilane, octadecyltriethoxysilane, methyloctyldiethoxysilane, dimethyldimethoxysilane, methyltrimethoxysilane, propyltrimethoxysilane, hexyltrimethoxysilane, heptyltrimethoxysilane, nonyltrimethoxysilane, decyltrimethoxysilane, dodecyltrimethoxysilane, tetradecyltrimethoxysilane, octadecyl-trimethoxysilane, methyloctyl dimethoxysilane, and mixtures thereof.

Non-limiting examples of bis(trialkoxysilylorgano)polysulfides suitable for use in certain embodiments include bis(trialkoxysilylorgano) disulfides and bis(trialkoxysilylorgano)tetrasulfides. Specific non-limiting examples of bis(trialkoxysilylorgano)disulfides include, but are not limited to, 3,3′-bis(triethoxysilylpropyl) disulfide, 3,3′-bis(trimethoxysilylpropyl)disulfide, 3,3′-bis(tributoxysilylpropyl)disulfide, 3,3′-bis(tri-t-butoxysilylpropyl)disulfide, 3,3′-bis(trihexoxysilylpropyl)disulfide, 2,2′-bis(dimethylmethoxysilylethyl)disulfide, 3,3′-bis(diphenylcyclohexoxysilylpropyl)disulfide, 3,3′-bis(ethyl-di-sec-butoxysilylpropyl)disulfide, 3,3′-bis(propyldiethoxysilylpropyl)disulfide, 12,12′-bis(triisopropoxysilylpropyl)disulfide, 3,3′-bis(dimethoxyphenylsilyl-2-methylpropyl)disulfide, and mixtures thereof. Non-limiting examples of bis(trialkoxysilylorgano)tetrasulfide silica coupling agents suitable for use in certain embodiments include, but are not limited to, bis(3-triethoxysilylpropyl)tetrasulfide, bis(2-triethoxysilylethyl) tetrasufide, bis(3-trimethoxysilylpropyl)tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Bis(3-triethoxysilylpropyl)tetrasulfide is sold commercially as Si69® by Evonik Degussa Corporation.

Non-limiting examples of mercapto silanes suitable for use in certain embodiments disclosed herein include, but are not limited to, 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Non-limiting examples of blocked mercapto silanes suitable for use in certain embodiments disclosed herein include, but are not limited to, those described in U.S. Pat. Nos. 6,127,468; 6,204,339; 6,528,673; 6,635,700; 6,649,684; and 6,683,135, the disclosures of which are hereby incorporated by reference. Representative examples of the blocked mercapto silanes include, but are not limited to, 2-triethoxysilyl-1-ethylthioacetate; 2-trimethoxysilyl-1-ethylthioacetate; 2-(methyldimethoxysilyl)-1-ethylthioacetate; 3-trimethoxysilyl-1-propylthioacetate; triethoxysilylmethyl-thioacetate; trimethoxysilylmethylthioacetate; triisopropoxysilylmethylthioacetate; methyldiethoxysilylmethylthioacetate; methyldimethoxysilylmethylthioacetate; methyldiisopropoxysilylmethylthioacetate; dimethylethoxysilylmethylthioacetate; dimethylmethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-(methyldiisopropoxysilyl)-1-ethylthioacetate; 2-(dimethylethoxysilyl-1-ethylthioacetate; 2-(dimethylmethoxysilyl)-1-ethylthioacetate; 2-(dimethylisopropoxysilyl)-1-ethylthioacetate; 3-triethoxysilyl-1-propylthioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-methyldiacetoxysilyl-1-ethylthioacetate; 2-triacetoxysilyl-1-ethylthioacetate; 1-methyldiacetoxysilyl-1-ethylthioacetate; 1-triacetoxysilyl-1-ethyl-thioacetate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1 propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulfate; 3-triethoxysilyl-1-propylmethanethiosulfonate; 3-triethoxysilyl-1-propylethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilylmethylmethylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like. Mixtures of various blocked mercapto silanes can be used. A further example of a suitable blocked mercapto silane for use in certain exemplary embodiments is NXT™ silane (3-octanoylthio-1-propyltriethoxysilane), commercially available from Momentive Performance Materials Inc. of Albany, NY.

Non-limiting examples of pre-treated silicas (i.e., silicas that have been pre-surface treated with a silane) suitable for use in certain embodiments o disclosed herein include, but are not limited to, Ciptane® 255 LD and Ciptane® LP (PPG Industries) silicas that have been pre-treated with a mercaptosilane, and Coupsil® 8113 (Degussa) that is the product of the reaction between organosilane bis(triethoxysilylpropyl) polysulfide (Si69) and Ultrasil® VN3 silica. Coupsil 6508, Agilon 400™ silica from PPG Industries, Agilon 454® silica from PPG Industries, and 458© silica from PPG Industries. In those embodiments where the silica comprises a pre-treated silica, the pre-treated silica is used in an amount as previously disclosed for the silica filler (i.e., 20-70 phr or 20-60 phr, etc.).

When a silica coupling agent is utilized in an embodiment, the amount used may vary. In certain embodiments, the rubber compositions do not contain any silica coupling agent. In other preferred embodiments, the silica coupling agent is present in an amount sufficient to provide a ratio of the total amount of silica coupling agent to silica filler of about 0.1:100 to about 1:5 (i.e., about 0.1 to about 20 parts by weight per 100 parts of silica), including 0.1:100 to 1:5, about 1:100 to about 1:10, 1:100 to 1:10, about 1:100 to about 1:20, 1:100 to 1:20, about 1:100 to about 1:25, and 1:100 to 1:25 as well as about 1:100 to about 0:100 and 1:100 to 0:100. In preferred embodiments, the ratio of the total amount of silica coupling agent to silica filler falls within a ratio of 1:10 to 1:20 (i.e., 10 to 5 parts by weight per 100 parts of silica). In certain embodiments, the rubber composition comprises about 0.1 to about 15 phr silica coupling agent, including 0.1 to 15 phr (e.g., 0.1, 0.5, 1, 2, 3, 4, 5, 6, 7, 8, 9, 10, 11, 12, 13, 14, or 15 phr), about 0.1 to about 12 phr, 0.1 to 12 phr, about 0.1 to about 10 phr, 0.1 to 10 phr, about 0.1 to about 7 phr, 0.1 to 7 phr, about 0.1 to about 5 phr, 0.1 to 5 phr, about 0.1 to about 3 phr, 0.1 to 3 phr, about 1 to about 15 phr, 1 to 15 phr (e.g., 1, 2, 3, 4, 5, 6, 7, 8, 9, 10, 11, 12, 13, 14, or 15 phr), about 1 to about 12 phr, 1 to 12 phr (e.g., 1, 2, 3, 4, 5, 6, 7, 8, 9, 10, 11, or 12 phr), about 1 to about 10 phr, 1 to 10 phr (e.g., 1, 1.5, 2, 2.5, 3, 3.5, 4, 4.5, 5, 5.5, 6, 6.5, 7, 7.5, 8, 8.5, 9, 9.5, or 10 phr), about 1 to about 7 phr, 1 to 7 phr, about 1 to about 5 phr, 1 to 5 phr, about 1 to about 3 phr, 1 to 3 phr, about 3 to about 15 phr, 3 to 15 phr, about 3 to about 12 phr, 3 to 12 phr, about 3 to about 10 phr, 3 to 10 phr, about 3 to about 7 phr, 3 to 7 phr, about 3 to about 5 phr, 3 to 5 phr, about 5 to about 15 phr, 5 to 15 phr, about 5 to about 12 phr, 5 to 12 phr, about 5 to about 10 phr, 5 to 10 phr, about 5 to about 7 phr, or 5 to 7 phr. In preferred embodiments, the rubber composition comprises silica coupling agent in an amount of 1 to 10 phr or one of the foregoing ranges falling within this range.

### Carbon Black Filler

According to certain embodiments disclosed herein, the amount of carbon black filler used in the rubber composition for the tread is 10 to 50 phr of carbon black filler (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 phr). In certain preferred embodiments of, the tread rubber composition contains 10-40 phr, 10-30 phr, 10-20 phr, 15-50 phr, 15-45 phr, 15-40 phr, 15-30 phr, 20-50 phr, 20-45 phr, 20-40 phr, 20-30 phr, 25-45 phr, 30-50 phr, 35-50 phr or 40-50 phr of carbon black filler. In certain embodiments, the amounts of carbon black filler should be understood to refer to reinforcing carbon black filler (in other words, 10 to 50 phr of reinforcing carbon black filler or 15-45 phr of reinforcing carbon black filler, etc. is used).

According to certain embodiments, the particular type or types of carbon black utilized may vary. Generally, suitable carbon blacks for use as a reinforcing filler in the rubber composition of certain embodiments include any of the commonly available, commercially-produced carbon blacks, including those having a surface area of at least about 50 m²/g (including at least 50 m²/g) and preferably, at least about 70 m²/g, an more preferably at least about 80 m²/g up to about 200 m²/g or higher (including 80 m²/g up to 200 m²/g). Surface area values used herein for carbon blacks are determined by ASTM D-1765 using the cetyltrimethyl-ammonium bromide (CTAB) technique. Among the useful carbon blacks are furnace black, channel blacks, and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks. In certain embodiments, the rubber composition includes a mixture of two or more of the foregoing blacks. Preferably according to certain embodiments, if a carbon black filler is present it consists of only one type (or grade) of reinforcing carbon black. Typical suitable carbon blacks for use in certain embodiments are N-110, N-220, N-234, N-339, N-330, and N-351, as designated by ASTM D-1765-82a. The carbon blacks utilized can be in pelletized form or an unpelletized flocculent mass. Preferably, for more uniform mixing, unpelletized carbon black is preferred.

### Other Reinforcing Fillers

In certain embodiments, the tread rubber composition comprises a reinforcing filler other than carbon black or silica (i.e., an additional reinforcing filler). While one or more than one additional reinforcing filler may be utilized, their total amount is preferably limited to no more than 10 phr (e.g., 10, 9, 8, 7, 6, 5, 4, 3, 2, 1 or 0 phr), or no more than 5 phr (e.g., 5, 4, 3, 2, 1, or 0 phr). In certain preferred embodiments, the tread rubber composition contains no additional reinforcing filler (i.e., 0 phr); in other words, in such embodiments no reinforcing filler other than silica and optionally carbon black are present.

In those embodiments wherein an additional reinforcing filler is utilized, the additional reinforcing filler or fillers may vary. Non-limiting examples of suitable additional reinforcing fillers for use in the rubber compositions of certain embodiments include, but are not limited to, alumina, aluminum hydroxide, clay (reinforcing grades), magnesium hydroxide, boron nitride, aluminum nitride, titanium dioxide, reinforcing zinc oxide, and combinations thereof.

### Non-Reinforcing Fillers

In certain embodiments, the rubber composition for the tread further comprises at least one non-reinforcing filler which is a non-carbon black non-reinforcing filler. In other preferred embodiments, the rubber composition contains no non-carbon black non-reinforcing fillers (i.e., 0 phr). In yet other embodiments, the rubber composition contains no non-reinforcing fillers (in such embodiments, the carbon black filler of the filler component will be a reinforcing carbon black filler). In embodiments wherein at least one non-carbon black non-reinforcing filler is utilized, the at least one non-reinforcing filler may be selected from clay (non-reinforcing grades), graphite, magnesium dioxide, aluminum oxide, starch, boron nitride (non-reinforcing grades), silicon nitride, aluminum nitride (non-reinforcing grades), calcium silicate, silicon carbide, ground rubber, and combinations thereof. The term “non-reinforcing filler” is used to refer to a particulate material that has a nitrogen absorption specific surface area (N₂SA) of less than about 20 m²/g (including less than 20 m²/g), and in certain embodiments less than about 10 m²/g (including less than 10 m²/g). The N₂SA surface area of a particulate material can be determined according to various standard methods including ASTM D6556. In certain embodiments, the term “non-reinforcing filler” is alternatively or additionally used to refer to a particulate material that has a particle size of greater than about 1000 nm (including greater than 1000 nm). In those embodiments, wherein a non-carbon black non-reinforcing filler is present in the rubber composition, the total amount of non-carbon black non-reinforcing filler may vary but is preferably no more than 20 phr (e.g., 20, 19, 18, 17, 16, 15, 14, 13, 12, 11, 10, 9, 8, 7, 6, 5, 4, 3, 2, or 1 phr), and in certain embodiments 1-10 phr, no more than 10 phr, no more than 5 phr (e.g., 5, 4, 3, 2, or 1 phr), 1-5 phr, or no more than 1 phr.

### Liquid Plasticizer

As mentioned above, according to certain embodiments, the rubber composition for the tire tread comprises (includes) 0 to 30 phr of a liquid plasticizer. By stating that the lower limit for the liquid plasticizer is 0 phr is meant that the liquid plasticizer component is optional in certain embodiments. The phrase liquid plasticizer should be understood to refer to plasticizers that are liquid at 25° C., including, but not limited, to oils and ester plasticizers. Generally, when a liquid plasticizer is used one or more than one liquid plasticizer may be utilized. The total amount of liquid plasticizer may be referred to as the amount of plasticizer component. In certain embodiments, the rubber composition includes 1 to 30 phr of liquid plasticizer (e.g., 1, 2, 4, 6, 8, 10, 12, 14, 15, 16, 18, 20, 22, 24, 25, 26, 28, or 30 phr) or an amount falling within the foregoing range such as 1 to 20 phr or 5 to 20 phr, preferably 10 to 30 phr (e.g., 10, 12, 14, 15, 16, 18, 20, 22, 24, 25, 26, 28, or 30 phr) of liquid plasticizer or an amount falling within such as 10 to 25 phr or 10 to 20 phr. The term oil is meant to encompass both free oil (which is usually added during the compounding process) and extender oil (which is used to extend a rubber). As a non-limiting example, by stating that the rubber composition includes 20 phr of oil it should be understood that the total amount of any free oil and any extender oil is 20 phr. Similarly, by stating that the rubber composition contains 20 phr of liquid plasticizer, it should be understood that the total amount of any liquid plasticizer (including free oil, extender oil, and ester plasticizer) is 20 phr. In certain embodiments, when the tread rubber composition contains oil, the only oil is free oil in one of the foregoing amounts (e.g., 1 to 30 phr, 10 to 30 phr, 5 to 20 phr, etc.). In other embodiments, when the tread rubber composition contains oil, the only oil is extender oil in one of the foregoing amounts (e.g., 1 to 30 phr, 10 to 30 phr, 5 to 20 phr, etc.). In those embodiments wherein an oil-extended rubber is used the amount of oil used to prepare the oil-extended rubber may vary; in certain such embodiments, the amount of extender oil present in the oil-extended rubber (polymer) is 10-50 parts oil per 100 parts of rubber (e.g., 10, 15, 20, 25, 30, 35, 40, 45 or 50 parts oil per 100 parts of rubber), preferably 10-40 parts oil per 100 parts of rubber or 20-40 parts oil per 100 parts of rubber. When an oil-extended rubber is used in the elastomer component of the rubber composition disclosed herein, the amounts specified for the rubber(s) of the elastomer component, as discussed above, should be understood to refer to the amounts of rubber only rather than the amounts of oil-extended rubber. As a non-limiting example, extender oil could be used in an amount of 40 parts oil per 100 parts rubber in an SBR used in an amount of 15 parts in the overall rubber composition and, thus, the amount of oil contributed by the oil-extended SBR to the rubber composition would be described as 6 phr.

As used herein, oil refers to both petroleum based oils (e.g., aromatic, naphthenic, and low PCA oils) as well as plant oils (such as can be harvested from vegetables, nuts, and seeds). Plant oils will generally comprise triglycerides and the term should be understood to include synthetic triglycerides as well as those actually sourced from a plant.

According to certain embodiments when one or more oils are present in the rubber composition, various types of processing and extender oils may be utilized, including, but not limited to aromatic, naphthenic, and low PCA oils (petroleum-sourced or plant-sourced). Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Exemplary petroleum-sourced low PCA oils include mild extraction solvates (MES), treated distillate aromatic extracts (TDAE), TRAE, and heavy naphthenics. Exemplary MES oils are available commercially as CATENEX SNR from SHELL, PROREX 15, and FLEXON 683 from EXXONMOBIL, VIVATEC 200 from BP, PLAXOLENE MS from TOTAL FINA ELF, TUDALEN 4160/4225 from DAHLEKE, MES-H from REPSOL, MES from Z8, and OLIO MES S201 from AGIP. Exemplary TDAE oils are available as TYREX 20 from EXXONMOBIL, VIVATEC 500, VIVATEC 180, and ENERTHENE 1849 from BP, and EXTENSOIL 1996 from REPSOL. Exemplary heavy naphthenic oils are available as SHELLFLEX 794, ERGON BLACK OIL, ERGON H2000, CROSS C2000, CROSS C2400, and SAN JOAQUIN 2000L. Exemplary low PCA oils also include various plant-sourced oils such as can be harvested from vegetables, nuts, and seeds. Non-limiting examples include, but are not limited to, soy or soybean oil, sunflower oil (including high oleic sunflower oil), safflower oil, corn oil, linseed oil, cotton seed oil, rapeseed oil, cashew oil, sesame oil, camellia oil, jojoba oil, hemp oil, macadamia nut oil, coconut oil, and palm oil. The foregoing processing oils can be used as an extender oil, i.e., to prepare an oil-extended polymer or copolymer or as a processing or free oil.

In those embodiments wherein one or more oils are present in the rubber composition, the Tg of the oil or oils used may vary. In certain embodiments, any oil utilized has a Tg of about −40 to about −100° C., −40 to −100° C. (e.g., −40, −45, −50, −55, −60, −65, −70, −75, −80, −85, −90, −95, or −100° C.), about −40 to about −90° C., −40 to −90° C. (e.g., −40, −45, −50, −55, −60, −65, −70, −75, −80, −85, or −90° C.), about −45 to about −85° C., −45 to −85° C. (e.g., −45, −50, −55, −60, −65, −70, −75, −80, or −85° C.), about −50 to about −80° C., or −50 to −80° C. (e.g., −50, −55, −60, −65, −70, −75, or −80° C.).

Preferably according to certain embodiments, the rubber composition contains less than 5 phr (e.g., 4.5, 4, 3, 2, 1, or 0 phr) of MES or TDAE oil, preferably no MES or TDAE oil (i.e., 0 phr). In certain embodiments, the rubber composition contains no petroleum oil (i.e., 0 phr) and instead any oil utilized is a plant oil. In certain embodiments, the rubber composition contains soybean oil in one of the above-mentioned amounts; in certain such embodiments the only oil included is soybean oil. In certain embodiments, the rubber composition contains no sunflower oil (i.e., 0 phr). In other embodiments, the only oil included is sunflower oil.

In certain embodiments, the tread rubber composition includes one or more ester plasticizers, which is a type of plasticizer that is generally liquid at room temperature. Suitable ester plasticizers are known to those of skill in the art and include, but are not limited to, phosphate esters, phthalate esters, adipate esters and oleate esters (i.e., derived from oleic acid). Taking into account that an ester is a chemical compound derived from an acid wherein at least one —OH is replaced with an —O-alkyl group, various alkyl groups may be used in suitable ester plasticizers for use in the tread rubber compositions, including generally linear or branched alkyl of C₁ to C₂₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀), or C₆ to C₁₂. Certain of the foregoing esters are based upon acids which have more than one —OH group and, thus, can accommodate one or more than one O-alkyl group (e.g., trialkyl phosphates, dialkyl phthalates, dialkyl adipates). Non-limiting examples of suitable ester plasticizers include trioctyl phosphate, dioctyl phthalate, dioctyl adipate, nonyl oleate, octyl oleate, and combinations thereof. The use of an ester plasticizer such as one or more of the foregoing may be beneficial to the snow or ice performance of a tire made from a tread rubber composition containing such ester plasticizer at least in part due to the relatively low Tg of ester plasticizers. In certain embodiments, the tread rubber composition includes one or more ester plasticizers having a Tg of −40° C. to −70° C. (e.g., −40, −45, −50, −55, −60, −65, or −70° C.), or −50° C. to −65° C. (e.g., −50, −51, −52, −53, −54, −55, −56, −57, −58, −59, −60, −61, −62, −63, −64, or −65° C.). In those embodiments wherein one or more ester plasticizers is utilized the amount utilized may vary. In certain embodiments, one or more ester plasticizers are utilized in a total amount of 1-25 phr (e.g., 1, 2, 3, 4, 5, 6, 7, 8, 9, 10, 11, 12, 13, 14, 15, 16, 17, 18, 19, 20, 21, 22, 23, 24, or 25 phr), 1-20 phr (e.g., 1, 2, 3, 4, 5, 6, 7, 8, 9, 10, 11, 12, 13, 14, 15, 16, 17, 18, 19, or 20 phr), 1-15 phr (e.g., 1, 2, 3, 4, 5, 6, 7, 8, 9, 10, 11, 12, 13, 14, or 15 phr), 1-10, phr (e.g., 1, 2, 3, 4, 5, 6, 7, 8, 9, or 10 phr), 2-6 phr (e.g., 2, 3, 4, 5, or 6 phr) or 2-5 phr (e.g., 2, 3, 4, or 5 phr). In certain preferred embodiments, the amount of any ester plasticizer is no more than 15 phr or no more than 12 phr. In certain embodiments, one or more ester plasticizers are used (in one of the foregoing amounts) in combination with oil where the oil is present in an amount of 1 to less than 10 phr, or 1-5 phr. In other embodiments, one or more ester plasticizers is used without any oil being present in the tread rubber composition (i.e., 0 phr of oil).

### Cure Package

As discussed above, the rubber composition used for the tire tread includes (comprises) a cure package. Although the contents of the cure package may vary according to certain embodiments, generally, the cure package includes at least one of: a vulcanizing agent; a vulcanizing accelerator; a vulcanizing activator (e.g., zinc oxide, stearic acid, and the like); a vulcanizing inhibitor; and an anti-scorching agent. In certain embodiments, the cure package includes at least one vulcanizing agent, at least one vulcanizing accelerator, at least one vulcanizing activator and optionally a vulcanizing inhibitor and/or an anti-scorching agent. Vulcanizing accelerators and vulcanizing activators act as catalysts for the vulcanization agent. Various vulcanizing inhibitors and anti-scorching agents are known in the art and can be selected by one skilled in the art based on the vulcanizate properties desired.

Examples of suitable types of vulcanizing agents for use in certain embodiments, include but are not limited to, sulfur or peroxide-based curing components. Thus, in certain such embodiments, the cure package includes a sulfur-based curative or a peroxide-based curative. In preferred embodiments, the vulcanizing agent is a sulfur-based curative; in certain such embodiments the vulcanizing agent consists of (only) a sulfur-based curative. Examples of specific suitable sulfur vulcanizing agents include “rubbermaker's” soluble sulfur; sulfur donating curing agents, such as an amine disulfide, polymeric polysulfide, or sulfur olefin adducts; and insoluble polymeric sulfur. Preferably, the sulfur vulcanizing agent is soluble sulfur or a mixture of soluble and insoluble polymeric sulfur. For a general disclosure of suitable vulcanizing agents and other components used in curing, e.g., vulcanizing inhibitor and anti-scorching agents, one can refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference. Vulcanizing agents can be used alone or in combination. Generally, the vulcanizing agents may be used in certain embodiments in an amount ranging from 0.1 to 10 phr (e.g., 0.1, 0.5, 1, 2, 3, 4, 5, 6, 7, 8, 9, or 10 phr), including from 1 to 7.5 phr, including from 1 to 5 phr, and preferably from 1 to 3.5 phr (e.g., 1, 1.5, 2, 2.5, 3, or 3.5 phr).

Vulcanizing accelerators are used to control the time and/or temperature required for vulcanization and to improve properties of the vulcanizate. Examples of suitable vulcanizing accelerators for use in certain embodiments disclosed herein include, but are not limited to, thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. Generally, the amount of the vulcanization accelerator used ranges from 0.1 to 10 phr (e.g., 0.1, 0.5, 1, 2, 3, 4, 5, 6, 7, 8, 9, or 10 phr), preferably 0.5 to 5 phr (e.g., 0.5, 1, 1.5, 2, 2.5, 3, 3.5, 4, 4.5, or 5 phr). Preferably, any vulcanization accelerator used in the rubber compositions of certain embodiments excludes any thiurams such as thiuram monosulfides and thiuram polysulfides (examples of which include TMTM (tetramethyl thiuram monosulfide), TMTD (tetramethyl thiuram disulfide), DPTT (dipentamethylene thiuram tetrasulfide), TETD (tetraethyl thiuram disulfide), TiBTD (tetraisobutyl thiuram disulfide), and TBzTD (tetrabenzyl thiuram disulfide)); in other words, the rubber compositions of certain embodiments preferably contain no thiuram accelerators (i.e., 0 phr).

Vulcanizing activators are additives used to support vulcanization. Generally vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Generally, in certain embodiments the amount of vulcanization activator used ranges from 0.1 to 6 phr (e.g., 0.1, 0.5, 1, 1.5, 2, 2.5, 3, 3.5, 4, 4.5, 5, 5.5, or 6 phr), preferably 0.5 to 4 phr (e.g., 0.5, 1, 1.5, 2, 2.5, 3 3.5, or 4 phr). In certain embodiments, both zinc oxide and stearic acid are used as vulcanizing activators with the total amount utilized falling within one of the foregoing ranges; in certain such embodiments, the only vulcanizing activators used are zinc oxide and stearic acid. In certain embodiments, one or more vulcanization activators are used which includes one or more thiourea compounds (used in the of the foregoing amounts), and optionally in combination with one or more of the foregoing vulcanization activators. Generally, a thiourea compound can be understood as a compound having the structure (R¹)(R²)NS(═C)N(R³)(R⁴) wherein each of R¹, R², R³, and R⁴ are independently selected from H, alkyl, aryl, and N-containing substituents (e.g., guanyl). Optionally, two of the foregoing structures can be bonded together through N (removing one of the R groups) in a dithiobiurea compound. In certain embodiments, one of R¹ or R² and one of R³ or R⁴ can be bonded together with one or more methylene groups (—CH₂—) therebetween. In certain embodiments, the thiourea has one or two of R¹, R², R³ and R⁴ selected from one of the foregoing groups with the remaining R groups being hydrogen. Exemplary alkyl include C1-C6 linear, branched or cyclic groups such as methyl, ethyl, propyl, iso-propyl, butyl, iso-butyl, pentyl, hexyl, and cyclohexyl. Exemplary aryl include C6-C12 aromatic groups such as phenyl, tolyl, and naphthyl. Exemplary thiourea compounds include, but are not limited to, dihydrocarbylthioureas such as dialkylthioureas and diarylthioureas. Non-limiting examples of particular thiourea compounds include one or more of thiourea, N,N′-diphenylthiourea, trimethylthiourea, N,N′-diethylthiourea (DEU), N,N′-dimethylthiourea, N,N′-dibutylthiourea, ethylenethiourea, N,N′-diisopropylthiourea, N,N′-dicyclohexylthiourea, 1,3-di(o-tolyl)thiourea, 1,3-di(p-tolyl)thiourea, 1,1-diphenyl-2-thiourea, 2,5-dithiobiurea, guanylthiourea, 1-(1-naphthyl)-2-thiourea, 1-phenyl-2-thiourea, p-tolylthiourea, and o-tolylthiourea. In certain embodiments, the activator includes at least one thiourea compound selected from thiourea, N,N′-diethylthiourea, trimethylthiourea, N,N′-diphenylthiourea, and N-N′-dimethylthiourea.

Vulcanization inhibitors are used to control the vulcanization process and generally retard or inhibit vulcanization until the desired time and/or temperature is reached. Common vulcanization inhibitors include, but are not limited to, PVI (cyclohexylthiophthalmide) from Santogard. Generally, in certain embodiments the amount of vulcanization inhibitor is 0.1 to 3 phr (e.g., 0.1, 0.5, 1, 1.5, 2, 2.5, or 3 phr), preferably 0.5 to 2 phr (e.g., 0.5, 1, 1.5, or 2 phr).

### Other Ingredients

Various other ingredients that may optionally be added to the rubber compositions of certain embodiment as disclosed herein include waxes (which in some instances are antioxidants), processing aids, reinforcing resins, peptizers, and antioxidants/antidegradant. Ingredients which are antidegradants may also be classified as an antiozonant or antioxidant, such as those selected from: N,N′disubstituted-p-phenylenediamines, such as N-1,3-dimethylbutyl-N′phenyl-p-phenylenediamine (6PPD), N,N′-Bis(1,4-dimethylpently)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of antidegradants include, acetone diphenylamine condensation product, 2,4-Trimethyl-1,2-dihydroquinoline, Octylated Diphenylamine, 2,6-di-t-butyl-4-methyl phenol and certain waxes. In certain other embodiments, the composition may be free or essentially free of antidegradants such as antioxidants or antiozonants.

### Preparing the Rubber Compositions

The particular steps involved in preparing the rubber compositions disclosed herein are generally those of conventionally practiced methods comprising mixing the ingredients in at least one non-productive master-batch stage and a final productive mixing stage. In certain embodiments, the tread rubber composition is prepared by combining the ingredients for the rubber composition (as disclosed above) by methods known in the art, such as, for example, by kneading the ingredients together in a Banbury mixer or on a milled roll. Such methods generally include at least one non-productive master-batch mixing stage and a final productive mixing stage. The term non-productive master-batch stage is known to those of skill in the art and generally understood to be a mixing stage (or stages) where no vulcanizing agents or vulcanization accelerators are added. The term final productive mixing stage is also known to those of skill in the art and generally understood to be the mixing stage where the vulcanizing agents and vulcanization accelerators are added into the rubber composition. In certain embodiments, the rubber composition is prepared by a process comprising more than one non-productive master-batch mixing stage.

In certain preferred embodiments, the tread rubber composition is prepared by a process wherein the master-batch mixing stage includes at least one of tandem mixing or intermeshing mixing. Tandem mixing can be understood as including the use of a mixer with two mixing chambers with each chamber having a set of mixing rotors; generally, the two mixing chambers are stacked together with the upper mixer being the primary mixer and the lower mixer accepting a batch from the upper or primary mixer. In certain embodiments, the primary mixer utilizes intermeshing rotors and in other embodiments the primary mixer utilizes tangential rotors. Preferably, the lower mixer utilizes intermeshing rotors. Intermeshing mixing can be understood as including the use of a mixer with intermeshing rotors. Intermeshing rotors refers to a set of rotors where the major diameter of one rotor in a set interacts with the minor diameter of the opposing rotor in the set such that the rotors intermesh with each other. Intermeshing rotors must be driven at an even speed because of the interaction between the rotors. In contrast to intermeshing rotors, tangential rotors refers to a set of rotors where each rotor turns independently of the other in a cavity that may be referred to as a side. Generally, a mixer with tangential rotors will include a ram whereas a ram is not necessary in a mixer with intermeshing rotors.

Generally, the rubbers (or polymers) and at least one reinforcing filler (as well as any silane coupling agent, liquid plasticizers and resin) will be added in a non-productive or master-batch mixing stage or stages. Generally, at least the vulcanizing agent component and the vulcanizing accelerator component of a cure package will be added in a final or productive mixing stage.

In certain embodiments, the rubber composition is prepared using a process wherein at least one non-productive master batch mixing stage is conducted at a temperature of about 130° C. to about 200° C. In certain embodiments, the tread rubber composition is prepared using a final productive mixing stage conducted at a temperature below the vulcanization temperature in order to avoid unwanted pre-cure of the rubber composition. Therefore, the temperature of the productive or final mixing stage generally should not exceed about 120° C. and is typically about 40° C. to about 120° C., or about 60° C. to about 110° C. and, especially, about 75° C. to about 100° C. In certain embodiments, the tread rubber composition is prepared according to a process that includes at least one non-productive mixing stage and at least one productive mixing stage. The use of silica fillers may optionally necessitate a separate re-mill stage for separate addition of a portion or all of such filler. This stage often is performed at temperatures similar to, although often slightly lower than, those employed in the masterbatch stage, i.e., ramping from about 90° C. to a drop temperature of about 150° C.

Properties of The Rubber Composition Used for the Tire Tread

Measurements of tan 6 at 0° C. can be used to quantify the expected wet performance of the rubber compositions when they are incorporated into tire treads. Tan 6 values can be measured with a dynamic mechanical thermal spectrometer (Eplexor® 500N from Gabo Qualimeter Testanlagen GmbH ofAhiden, Germany) generally following the guidelines of ASTM D5992-96 (2011) under the following conditions: measurement mode: tensile test mode; measuring frequency: 52 Hz; temperature sweep measurement, applying 0.2% strain from −50 to −5° C. and 1% strain from −5 to 65° C., with the starting temperature being somewhat below −50° C. and the ending temperature being somewhat above −5° C.; collecting data approximately every 1° C. in order to provide measurements at temperatures of −30° C., 0° C., 30° C., and 60° C.; sample shape: 4.75 mm wide×29 mm long×2.0 mm thick. Measurement is made upon a cured sample of rubber (cured for 15 minutes at 170° C.). A rubber composition's tan 6 at 0° C. is indicative of its wet traction when incorporated into a tire tread.

In certain embodiments, the rubber composition for the tire tread has a wet performance as measured by tan 6 at 0° C. of at least 0.40 (e.g., 0.40, 0.41, 0.42, 0.43, 0.44, 0.45, 0.46, 0.47, 0.48, or more), preferably at least 0.45 (e.g., 0.45, 0.46, 0.47, 0.48, 0.49, 0.5, or more). In certain embodiments, the rubber composition for the tire tread has a wet performance as measured by tan 6 at 0° C. of 0.4-0.6, 0.42-0.55, or 0.42-0.5, preferably 0.45-0.6, 0.45-0.55, or 0.45-0.5. In preferred certain embodiments, the rubber composition for the tire tread has a wet performance falling within one of the foregoing ranges in combination with other properties as described below

After curing, tensile properties of the rubber compositions can be determined. Values for elongation at break and stress at break, which measurements provide an indication of a rubber composition's tear resistance or toughness, are particularly relevant for tire tread applications. Tensile stress at 300% elongation can also be measured. Tensile mechanical properties of the samples can be determined following the guidelines, but not restricted to, the standard procedure described in ASTM D-412, using dumbbell-shaped samples with across-section dimension of 4 mm in width and 1.9 mm in thickness at the center. Specimens can be strained at a constant rate and the resulting force recorded as a function of extension (strain). The specimens can be cured for 40 minutes at 150° C., and tested at 25° C. and/or at 100° C.

In certain embodiments, the rubber composition for the tire tread has an elongation at break at 100° C. of at least 400 MPa (e.g., 400, 410, 420, 430, 440, 450, 460, 470, 480 MPa or more), preferably at least 450 MPa (e.g., 450, 460, 470, 480, 490, 500 MPa, or more) and more preferably at least 500 MPa (e.g., 500, 510, 520, 530, 540, 550 MPa, or more). In certain embodiments, the rubber composition for the tire tread has a stress at break at 100° C. of at least 10 MPa (e.g., 10, 10.1, 10.2, 10.3, 10.4, 10.5, 10.6, 10.7, 10.8, 10.9, 11 MPa or more), preferably at least 11 MPa (e.g., 11, 11.1, 11.2, 11.3, 11.4, 11.5, 11.6, 11.7, 11.8, 11.9, 12 MPa or more) and more preferably at least 12 MPa (e.g., 12, 12.1, 12.2, 12.3, 12.4, 12.5, 12.6, 12.7, 12.8, 12.9, 13 MPa or more). In certain embodiments, the rubber composition for the tire tread has a tensile stress at 300% elongation at 100° C. of at least 5 MPa (e.g., 5, 5.1, 5.2, 5.3, 5.4, 5.5, 5.6, 5.7, 5.8, 5.9, 6 MPa or more), preferably at least 6 MPa (e.g., 6, 6.1, 6.2, 6.3, 6.4, 6.5, 6.6, 6.7, 6.8, 6.9, 7 MPa or more) and more preferably at least 6.5 MPa (e.g., 6.5, 6.6, 6.7, 6.8, 6.9, 7 MPa or more). In preferred certain embodiments, the rubber composition for the tire tread has tensile properties falling within one of the foregoing ranges in combination with wet performance properties as described above.

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” All references, including but not limited to patents, patent applications, and non-patent literature are hereby incorporated by reference herein in their entirety. While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A tire comprising a tread rubber composition comprising:
100 parts of an elastomer component comprising at least 50 parts of rubber selected from the group consisting of natural rubber and polyisoprene, and
5 to 40 phr of a resin component comprising a DCPD-based resin, and
0 to 30 phr of a hydrocarbon resin other than a DCPD-based resin, and
10 to 50 phr of a carbon black filler, and
20 to 70 phr of a reinforcing silica filler, and
0 to 10 phr of a silica coupling agent
0 to 30 phr of a liquid plasticizer, and
a cure package.

2. The tire of claim 1, wherein the elastomer component comprises at least 20 parts, preferably at least 30 parts of polybutadiene having a cis-bond content of at least 90% and a Tg of less than −100° C.

3. The tire of claim 1 or claim 2, wherein at least a portion of the natural rubber is guayule natural rubber.

4. The tire of any one of claims 1-3, wherein the elastomer component comprises from 1-25 parts of styrene-butadiene rubber.

5. The tire of any one of claims 1-4, wherein the DCPD-based resin has a minority by weight of DCPD monomers.

6. The tire of any one of claims 1-5, wherein the DCPD-based resin has a majority by weight of DCPD monomers, preferably at least 60%, at least 70%, at least 80%, or at least 90% by weight of DCPD monomers.

7. The tire of any one of claims 1-6, wherein the reinforcing silica filler has a BET surface area of about 140 to about 230 m²/g.

8. The tire of any one of claims 1-7, wherein the reinforcing silica filler has a BET surface area of about 100 to about 140 m²/g.

9. The tire of any one of claims 1-8, wherein the carbon black filler has a N₂ surface area of greater than 70 m²/g.

10. The tire of any one of claims 1-9, wherein the carbon black filler has a N₂ surface area of greater than 100 m²/g.

12. The tire of any one of claims 1-11, wherein the hydrocarbon resin is present in an amount of from 1 to 20 phr.

13. The tire of any one of claims 1-12, wherein the hydrocarbon resin is present in an amount of from 1 to 10 phr.

14. The tire of any one of claims 1-13, wherein the rubber composition of the tread includes 1-10 phr of a liquid plasticizer.

15. The tire of any one of claims 1-14, wherein the rubber composition of the tread contains 0-5 phr liquid plasticizer.

16. The tire of any one of claims 1-15, wherein the filler component includes 10-50 phr of reinforcing carbon black filler, preferably 15-45 phr of reinforcing carbon black filler.

17. The tire of any one of claims 1-16, wherein the tread rubber composition has a 300% modulus at 100° C. of at least 5 MPa, preferably at least 6 MPa, more preferably at least 6.5 MPa.

18. The tire of any one of claims 1-17, wherein the tread rubber composition has an elongation at break at 100° C. of at least 400 MPa, preferably at least 450 MPa, more preferably at least 500 MPa.

19. The tire of any one of claims 1-18, wherein the tread rubber composition has a stress at break at 100° C. of at least 10 MPa, preferably at least 11 MPa, more preferably at least 12 MPa.

20. The tire of any one of claims 1-19, wherein the rubber composition has a wet performance as measured by tan 6 at 0° C. of at least 0.3, preferably at least 0.31, more preferably at least 0.32.
